(19) United States
(12) Patent Application Publication
(10) Pub. No.: US 2003/0103700 A1
(43) Pub. Date: Jun. 5, 2003

(54) Contact rolling bearing

(75) Inventor: Francesco Gallucci, Nichelino (IT)

Correspondence Address: MERCHANT & GOULD PC, P.O. BOX 2903, MINNEAPOLIS, MN, 55402-0903, US

(73) Assignee: SKF Industrie S.p.A., Torino (IT)

(21) Appl. No.: 10/302,540

(22) Filed: Nov. 22, 2002

(30) Foreign Application Priority Data
Nov. 30, 2001 (IT) T02001A001122

(51) Int. Cl. F16C 33/76

(52) U.S. Cl. 384/477; 384/484

(57) ABSTRACT

Rolling contact bearing (1) which comprises an outer race (2), and a series of rolling bodies (4) which are arranged between the two races (2, 3), and at least one sealing covering (5) arranged laterally to the rolling bodies (4) and between the two races (2, 3); the rolling contact bearing (1)* being characterised by the fact that it also comprises at least one extra shield (15) which is integral to the inner race (3) and which is arranged laterally to increase the sealing capacity of the covering (5) itself.

### DESCRIPTION

The present invention refers to a contact rolling bearing.

In general, rolling contact bearings of a well-known type comprise an outer race, an inner race which is co-axial to the outer race, a series of rolling bodies which are arranged between the two races, and two sealing coverings which are arranged on either side of the rolling bodies and between the two races in order to prevent any impurities or suchlike from entering inside the rolling contact bearing itself.

In some kinds of applications, the type of rolling contact bearing described above is mounted together with at least one extra shield, which is defined by a race which is arranged laterally to a covering of the rolling contact bearing, and which is suitable for increasing the sealing characteristics of the rolling contact bearings themselves.

Usually, this extra shield is independent of the rolling contact bearing and is subsequently blocked onto the rolling contact bearing itself during the assembly phase, but the fact of its presence is the source of several disadvantages, for example, a prolongation of the assembly time, and an increase in management and production costs, above all in the case that the rolling contact bearing and the extra shield come from two different suppliers.

The aim of the present invention is to produce a rolling contact bearing which is free of the above-described disadvantages.

According to the present invention, a rolling contact bearing will be produced comprising an outer race, an inner race which is co-axial to the outer race, a series of rolling bodies and which are arranged between the two races, and at least one sealing covering which is laterally arranged to the rolling bodies and between the two races; the rolling contact bearing is characterised by the fact that it also comprises at least one extra shield which is integral to the inner race and which is laterally arranged to the said sealing covering in order to increase the sealing capacity of the sealing covering itself.

The present invention will now be described with reference to the attached drawings, which illustrate a non-limiting form of embodiment of the present invention, and in which;

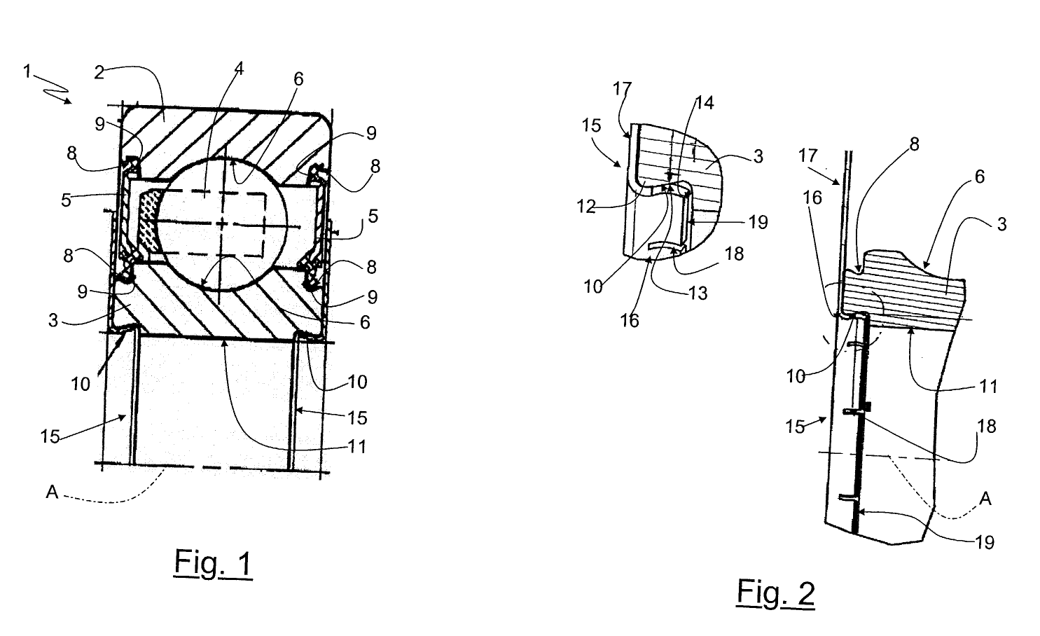

FIG. 1 illustrates, in transverse section, a preferred form of embodiment of the rolling contact bearing to which the present invention refers; and

FIG. 2 illustrates a detail of FIG. 1 on an enlarged scale.

With reference to FIG. 1, the number 1 indicates a rolling contact bearing in its entirety, presenting a rotation axis A and comprising an outer race 2, an inner race 3 which is co-axial to the outer race 2, a series of rolling bodies which are arranged between the two races 2 and 3, and two sealing coverings 5 which are arranged between the two races 2 and 3 themselves and which are arranged laterally to the rolling bodies 4 and transversally to the axis A.

From the part which is turned towards the rolling bodies 4, both the outer race 2 and the inner race 3 each present a respective sliding track 6 for the rolling bodies 4 themselves, and also present two respective annular notches 8, which are arranged on opposite sides of the relative track 6 and which are suitable for housing a respective edge 9 of the relative sealing covering 5.

The inner race 3 also presents, on the part which is opposite the relative track 6, two grooved housings 10 which are obtained in the place of inner corners of the inner race 3 itself, and which present a radial width which increases axially starting from the outside.

According to the illustration which is shown in FIG. 2, the inner race 3 is radially delimited towards the axis A by a cylindrical surface 11, and each housing 10 presents an external rounded annular sharp edge 12 which has an internal diameter which is less than an internal diameter of the cylindrical surface 11 itself. Furthermore, each housing 10 is radially delimited towards the outside by a surface 13 in the form of a tapering cone which is connected to the relative sharp edge 12, and which is axially delimited towards the inside by a flat surface 14 which is transverse to the axis A and which is, in turn, connected to the relative surface 13.

The rolling contact bearing 1 also comprises, for each sealing covering 5, an extra protection shield 15, which is arranged laterally to the relative sealing covering 5 in order to increase the sealing capacity of the covering 5 itself, and which is integral to the inner race 3.

In particular, each shield 15 comprises an assembly portion 16 which is arranged inside the housing 10, and a covering portion 17, which extends radially beyond the track 6 from the inner race 3 and which is arranged laterally to the relative covering 5.

The portion 17 is defined by an annular plate, which is arranged transversally to the axis A and which is radially superimposed over the relative sealing covering 5 for at least half of the radial height of the covering 5 itself.

The assembly portion 16, on the other hand, can be directly caulked inside the housing 10, or as an alternative, as illustrated, it may present a conformation which is substantially similar to that of the housing 10 n order to be snap inserted inside the housing 10 itself.

With this aim in mind, and in order to increase its flexibility, the assembly portion 16 is provided with a number of weakening notches 18, which are arranged at an equal distance one from the other, and which are obtained starting from a free edge 19 of the assembly portion 16 itself, and which define a number of other grooved tongues.

It is intended that the present invention should not be limited to the forms of embodiment which are herein described and illustrated, which are to be considered as examples of preferred forms of embodiment of a blocking device, which might be subject to further modifications relating to the shape and arrangement of its parts, as well as to details pertaining to its construction and assembly.

1. Rolling contact bearing (1) which comprises an outer race (2), an inner race (3) which is co-axial to the outer race 82), a series of rolling bodies (4) and which are arranged between the two races (2, 3), and at least one sealing covering (5) which is laterally arranged to the rolling bodies (4) and between the two races (2, 3); the rolling contact bearing (1) is characterised by the fact that it also comprises at least one extra shield (15) which is integral to the inner race (3) and which is laterally arranged to the said sealing covering (5) in order to increase the sealing capacity of the sealing covering (5) itself.

2. Rolling contact bearing according to claim 1, which is characterised by the fact that the inner race (3) presents a sliding track (6) for the said rolling bodies (4), and, on the opposite side of the track (6), a grooved housing (10); the said extra shield (15) presents an assembly portion (16) which is arranged inside the grooved housing (10), and a sliding portion (17) which extends radially beyond the sliding track ((6) and laterally beyond the said sealing covering (5).

3. Rolling contact bearing according to claim 2, characterised by the fact that the said grooved housing (10) is obtained in the place of an internal corner of the inner race (3) and presents a radial width which increases axially starting from the outside.

4. Rolling contact bearing according to claim 3, characterised by the fact that the assembly portion (16) is caulked inside the grooved housing (10).

5. Rolling contact bearing according to claim 4, characterised by the fact that the assembly portion (16) presents a shape which is substantially similar to that of the grooved housing (10) and is provided with a number of weakening notches (18) which are equally spaced in relation to each other in order to ensure that the assembly portion (16) is provided with a determined elasticity.

6. Rolling contact bearing according to any of the preceding claims, characterised by the fact that it comprises two extra shields (15) which are integral to the inner race (3) and which are arranged laterally to the two sealing coverings (5) in order to increase the sealing capacity of the coverings (5) themselves.
